(19) United States
(12) Patent Application Publication
(10) Pub. No.: US 2017/0007915 A1
(43) Pub. Date: Jan. 12, 2017

(54) SYSTEMS AND METHODS FOR AN INTERACTIVE ROBOTIC GAME

(71) Applicant: Play Works Studio, Inc., Normandy Park, WA (US)

(72) Inventors: Adriana Moscatelli, Normandy Park, WA (US); Dan Tebbs, Redmond, WA (US); James Arlie Englund, Ellensburg, WA (US); David Francis Englund, Ellensburg, WA (US)

(21) Appl. No.: 14/797,049

(22) Filed: Jul. 10, 2015

(51) Int. Cl. A63F 3/04; A63F 9/20; G09B 23/00; A63F 1/02

(52) U.S. Cl. CPC A63F 3/04; A63F 1/02; A63F 9/20; G09B 23/00

(57) ABSTRACT

Generally described, aspects of the disclosed subject matter are directed to systems and methods for controlling a robot using physical tiles embodied as an interactive robotic game. In accordance with one embodiment of the present disclosure, an interactive game system is provided. The interactive game system generally includes an interlocking game tile having a body, an interlocking component, an automatic data capture device configured for identification of a target position, and a path disposed on the top surface of the tile. The tile provides a surface and route for travel of a programmable robotic device having a body, a microprocessor, a path sensor, and an automatic data capture device reader. The programmable robotic device generally travels along the path of the game tiles to the target position where it interrogates the automatic data capture device of the game tile and performs actions based on the information received.

### BACKGROUND

Interactive games provide a natural learning environment for students who learn when an emphasis is placed on social interaction, narrative storytelling, and collaboration. Traditionally, science, technology, engineering, and math (STEM subjects) are not readily taught using the interactive game type of learning environment. As a result, teachers look for ways to gain more involvement in STEM subjects, which are typically taught with less active involvement using tangible objects.

Robotic systems designed for use with the traditional teaching method typically place little emphasis on social interaction and performing a series of social tasks with the robot. As a result, the students who thrive in a social environment can become disinterested in the STEM subjects and fall behind the students who have learning propensities more suited to the method of teaching.

Therefore, there exists a need for improved control of robots using interactive tiles as provided in games designed to enhance social interaction and physical development, particularly in the STEM subjects. Embodiments of the present disclosure are directed to fulfilling these and other needs.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, an interlocking tile for directing an action of a programmable robotic device is provided. The interlocking tile generally includes a body having a top surface and an edge portion, the edge portion having an interlocking component; an automatic data capture device associated with the body configured for storage of tile information and identification of a target position; and a path disposed on the top surface of the body connecting the edge portion and the target position, the path indicative of a travel route to the target position for the programmable robotic device. The interlocking component is removably couplable to an interlocking component of an edge portion of a second interlocking tile, and the programmable robotic device is configured to interrogate the automatic data capture device to receive the tile information.

In accordance with another embodiment of the present disclosure, a system is provided. The system generally includes a tile having a tile body with a top surface and an edge portion, the edge portion having an interlocking component; an automatic data capture device associated with the tile body configured for identification of a target position; and a path disposed on the top surface of the tile body connecting the edge portion and the target position, the path indicative of a travel route to the target position. The system generally further includes a programmable robotic device having a robot body; a microprocessor connected to the robot body; a sensor electrically connected to the microprocessor for detecting the path of the tile; an automatic data capture device reader electrically connected to the microprocessor for interrogating and receiving tile information from the automatic data capture device of the tile; an electric motor associated with the microprocessor; and a wheel drivingly connected to the electric motor for propelling the programmable robotic device. The microprocessor is configured to cause the programmable robotic device to travel along the travel route to the target position and complete the actions directed by the tile.

In accordance with another embodiment of the present disclosure, a method, using interlocking tiles described herein, is provided. The method generally includes coupling the interlocking component of a first interlocking tile to the interlocking component of a second interlocking tile, wherein the path of the first interlocking tile and the path of the second interlocking tile are aligned and together produce the travel route between the target position of the first interlocking tile and the target position of the second interlocking tile; communicating, by a computing device, instructions to the programmable robotic device to begin interrogating the first interlocking tile; receiving, by the programmable robotic device from the automatic data capture device, tile information from the first interlocking tile to the programmable robotic device, wherein the programmable robotic device completes an action based on the tile information received from the first interlocking tile; executing instructions by the programmable robotic device that cause the programmable robotic device to travel from the target position of the first interlocking tile to the target position of the second interlocking tile along the travel route and begin interrogating the automatic data capture device of the second interlocking tile; and receiving, by the programmable robotic device from the automatic data capture device, tile information from the second interlocking tile, wherein the programmable robotic device completes an action based on the tile information received from the second interlocking tile.

In accordance with any of the embodiments described herein, the automatic data capture device may be selected from the group consisting of Radio-Frequency Identification (RFID), a bar code, a matrix code, a magnetic stripe, Optical Character Recognition (OCR), April tag, Near Field Communication (NFC), Optical Position Marker (OPS), Optical RFID (OPID), RuBee tag, and an integrated circuit.

In accordance with any of the embodiments described herein, a portion of the tile information received from the automatic data capture device may include a location of the target position.

In accordance with any of the embodiments described herein, the target position may be the center of the top surface of the tile.

In accordance with any of the embodiments described herein, a portion of the tile information received from the automatic data capture device may include a tile type.

In accordance with any of the embodiments described herein, the tile type may include a unique identifier corresponding to one or more of a terrain, an environment, a superpower, and an action to be completed by the programmable robotic device.

In accordance with any of the embodiments described herein, the path may comprise a sensor material such that the travel route is detectable by sensors disposed on the programmable robotic device.

In accordance with any of the embodiments described herein, the travel route may guide the programmable robotic device to a target position of the second interlocking tile.

In accordance with any of the embodiments described herein, the sensor material may be selected from the group consisting of an infrared sensor paint, a sensor pigment enriched paint, a magnetic substrate, textured paper, textured plastic, textured fabric, a metal, and an eye-visible line.

In accordance with any of the embodiments described herein, the interlocking component may be removably couplable to an interlocking component of an edge portion of a second tile, wherein the path of the first tile and a path of the second tile together form the travel route, and wherein the programmable robotic device is configured to travel along the travel route from the target position of the first tile to a target position of the second tile and complete actions directed by the second tile.

In accordance with any of the embodiments described herein, the automatic data capture device of the tile may store information related to the type of tile and the actions the programmable robotic device completes when the target position is reached.

In accordance with any of the embodiments described herein, the programmable robotic device may further include a wireless communication device configured to communicate with a computing device to receive programming instructions.

In accordance with any of the embodiments described herein, the programmable robotic device may further include an exterior shell disposed around the robot body, wherein the shell is electrically connected to the microprocessor and configured to transmit characteristics and identity of the shell.

In accordance with any of the embodiments described herein, the characteristics of the shell may include a unique identifier corresponding to one or more of a character, a superpower, and an action to be completed by the programmable robotic device.

In accordance with any of the embodiments described herein, the programmable robotic device may not travel from the target position of the first interlocking tile to the target position of the second interlocking tile until receiving the instructions from a computing device.

In accordance with any of the embodiments described herein, the programmable robotic device may include a shell configured to transmit a unique identifier corresponding to one or more of a character, a superpower, and a further action to be completed by the programmable robotic device.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of a gameplay system formed in accordance with one embodiment of the present disclosure, showing various interlocking game tiles removably coupled together with a programmable robotic device on the travel surface;

FIG. 2 is an isometric view of one interlocking game tile of FIG. 1 formed in accordance with one embodiment of the present disclosure;

FIG. 3 is an isometric view of another interlocking game tile of FIG. 1 formed in accordance with another embodiment of the present disclosure;

FIG. 4 is an isometric view of another interlocking game tile of FIG. 1 formed in accordance with another embodiment of the present disclosure;

FIG. 5 is an isometric view of another interlocking game tile of FIG. 1 formed in accordance with another embodiment of the present disclosure;

FIG. 6 is an isometric view of another interlocking game tile of FIG. 1 formed in accordance with another embodiment of the present disclosure;

FIG. 7 is an exploded isometric view of the programmable robotic device of FIG. 1;

FIG. 8 is a block diagram that illustrates, at a high level, various components of an interactive game system in accordance with various aspects of an exemplary embodiment of the present disclosure;

FIG. 9 is a block diagram that illustrates an exemplary embodiment of the game management system of FIG. 8, according to various aspects of the present disclosure;

FIG. 10 is a block diagram that illustrates an exemplary embodiment of the computing device of FIG. 8, according to various aspects of the present disclosure;

FIG. 11 depicts a flow chart that illustrates an exemplary embodiment of a method of gameplay, using the interactive game system of FIG. 8, according to various aspects of the present disclosure; and

FIG. 12 is a block diagram that illustrates aspects of an exemplary computing device of the present disclosure.

### DETAILED DESCRIPTION

The detailed description set forth below in connection with the appended drawings, where like numerals reference like elements, are intended as a description of various embodiments of the present invention and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result.

In the following description, specific details are set forth to provide a thorough understanding of exemplary embodiments of the present invention. It will be apparent to one skilled in the art, however, that the invention may be practiced without embodying all of the specific details. In some instances, well-known process steps have not been described in detail in order not to unnecessarily obscure various aspects of the present disclosure. Further, it will be appreciated that embodiments of the present invention may employ any combination of features described herein.

The present application may include references to directions, such as “forward,” “rearward,” “front,” “back,” “upward,” “downward,” “right hand,” “left hand,” “lateral,” “medial,” “in,” “out,” “extended,” “advanced,” “retracted,” “proximal,” “distal,” “central,” etc. These references, and other similar references in the present application, are only to assist in helping describe and understand the particular embodiment and are not intended to limit the present invention to these directions or locations.

The present application may also reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc.

The term “player” is used throughout the present disclosure for ease of discussion to refer to a person involved in gameplay of the interactive robotic game. In some embodiments, a player may be a student using the game of the present disclosure in a classroom learning environment. However, the player is not limited to this example. The term “engine” is used throughout the present disclosure for ease of discussion to refer to logic embodied in hardware or software instructions, which can be written in a programming language, such as C, C++, COBOL, JAVA™, PHP, Perl, HTML, CSS, JavaScript, VBScript, ASPX, Microsoft .NET™ languages such as C#, and/or the like. In this regard, the terms “programming” and “programmable” are used to refer to the hardware or software instructions, as described above. An engine may be compiled into executable programs or written in interpreted programming languages. The engines or applications can be stored in any type of computer readable medium or computer storage device and be stored on and executed by one or more general purpose computers, thus creating a special purpose computer configured to provide the engine or application.

The term “data store” is used throughout the present disclosure for ease of discussion to refer to any suitable device configured to store data for access by a computing device. One example of a data store is a highly reliable, high-speed relational database management system (DBMS) executing on one or more computing devices and accessible over a high-speed packet switched network. However, any other suitable storage technique and/or device capable of quickly and reliably providing the stored data in response to queries may be used, and the computing device may be accessible locally instead of over a network, or may be accessible over some other type of suitable network or provided as a cloud-based service. One of ordinary skill in the art will recognize that separate data stores described herein may be combined into a single data store, and/or a single data store described herein may be separated into multiple data stores, without departing from the scope of the present disclosure.

Embodiments of the present disclosure are generally directed to systems and methods for controlling a robot using physical tiles. Some embodiments of the control of the robot using physical tiles include playing an interactive and programmable robotic game. In general, the robotic game described herein is an interactive game intended to teach the player problem solving, programming of robotics, game layout and design, fine motor skills, spatial reasoning, math skills, reading skills, music skills, and cloud computing methods, among other desired skills. Robotic games in accordance with the present invention are capable of including modularity in the game pieces, expansion series, collectable and rare game pieces, character development, additional programming parameters, and game development directly by the player.

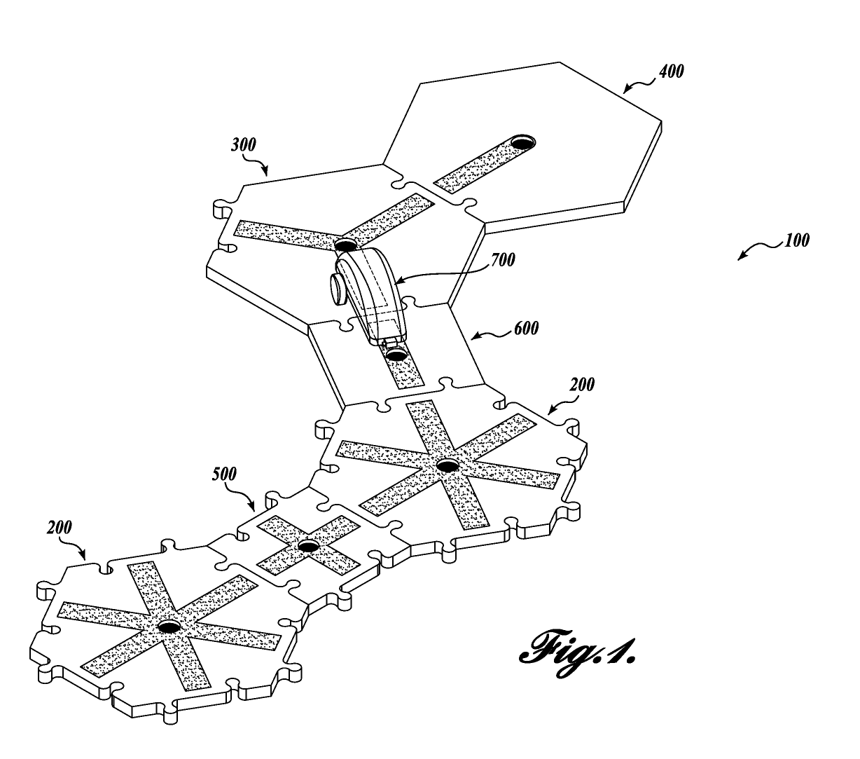

A programmable robotic game constructed in accordance with one embodiment of the present disclosure is shown in FIG. 1. At a minimum, a gameplay system 100 generally includes a hexagonal game tile 200 and a programmable robotic device 700. In some embodiments, hexagonal game tiles with different features and configurations are additionally included, such as a hexagonal game tile 300 and a hexagonal game tile 400, explained in more detail below. In other embodiments, a square game tile 500 and a square game tile 600 are included in the gameplay system 100. In general, the present application may use the term “game tile” in the generic sense to reference a hexagonal game tile, a square game tile, an interlocking game tile, a non-interlocking game tile, or a game tile of any shape.

The gameplay system 100 as shown in FIG. 1 is a graphical representation of one possible assembly configuration for the game tile layout and is not to be construed as a limitation of other embodiments. In that regard, in other embodiments of game tiles, any shape of tile is suitably used with the gameplay system 100 of the present disclosure. Likewise, the game tiles are illustrated as flat tiles with planar top surfaces; however, in other embodiments the tiles include non-planar topography.

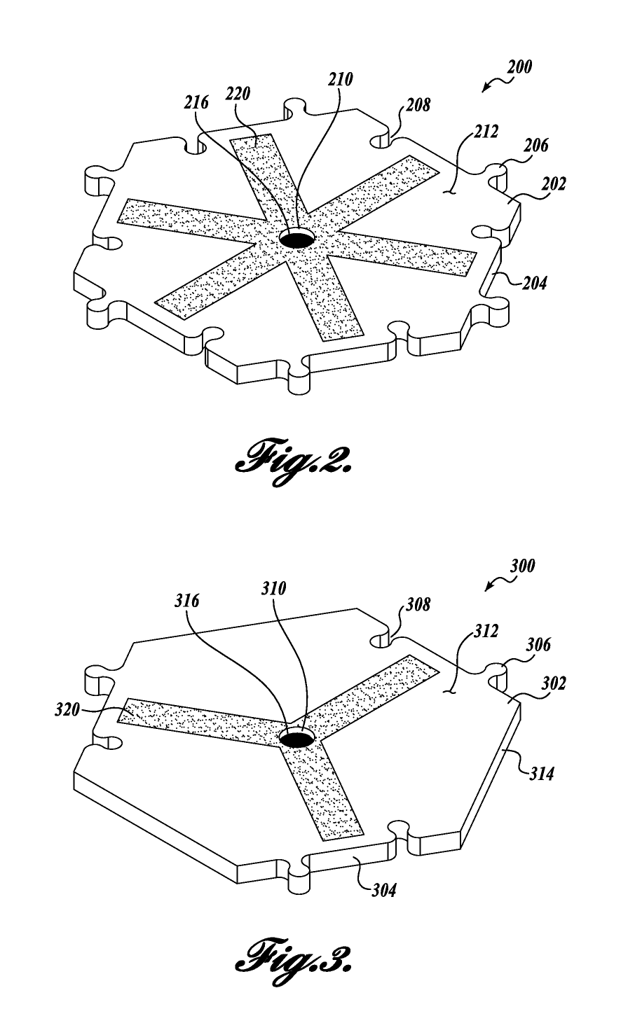

Referring to FIG. 2, the illustrated hexagonal game tile 200 includes a game tile body 202, an interlocking edge 204 with an interlock tab 206 and an interlock recess 208, a target position 210, a travel surface 212, an automatic data capture device 216, and a travel path 220. In the illustrated embodiment, the game tile body 202 is flat and has a height that is substantially less than the width. In other embodiments, the game tile is any suitable shape. The interlocking edge 204 is configured to releasably couple the hexagonal game tile 200 to other interlocking game tiles as shown in an exemplary configuration in FIG. 1. In this regard, in the embodiments of the present disclosure, any number or configuration of interlocking sides of the game tile are within the scope of the present disclosure. Although certain configurations are shown in FIGS. 2-6, the illustrations are not to be construed as limiting. In other embodiments, interlocking features may be omitted from the game tiles such that the game tiles are placed in a game tile layout configuration without any coupling. In further embodiments, certain alternative tiles (not shown) are permanently coupled.

The interlock tab 206 of the hexagonal game tile 200 is configured to correspond to the interlock recess 208 of a corresponding game tile. In the illustrated embodiment, the interlock tab 206 slides together with the interlock recess 208 from the vertical direction. In other embodiments, the interlock tab 206 suitably couples to the interlock recess 208 in any direction. In some embodiments, more than one tab and more than one recess are used. In other embodiments, interlocking edge schemes that do not comprise a tab and recess are used, such as a lockpin, tongue and groove, magnetic, or other suitable systems which are not illustrated in the present disclosure, but are generally known in the art.

The hexagonal game tile 200 is illustrated in FIG. 2 with a target position 210 in the center. In other embodiments, the target position 210 is located in any position on the hexagonal game tile 200. The target position 210 is the point to which the programmable robotic device 700 travels during gameplay. In this regard, the travel path 220 generally has convergence at the target position 210.

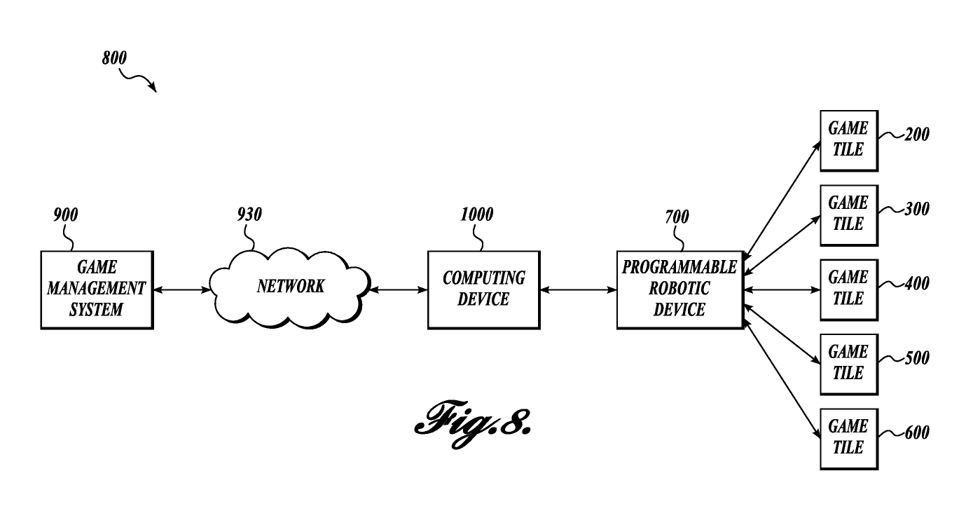

To enable the programmable robotic device to locate the target position 210, the automatic data capture device 216 is attached or embedded at the target position 210 as shown in FIG. 2. An automatic data capture sensor 740 (see FIG. 7) on the programmable robotic device 700 detects the automatic data capture device 216 on the hexagonal game tile 200 as the target position 210. In addition to marking the location of the target position 210, the automatic data capture device 216 retains game tile information regarding the hexagonal game tile 200. In this regard, once the programmable robotic device 700 reaches the target position 210, it interrogates the automatic data capture device 216 for further game tile information.

The automatic data capture device 216 is a device that can store data to be interpreted by a sensor. In the embodiments of the present disclosure, the automatic data capture device 216 is any device capable of storing data for retrieval by a sensor. In this regard, the automatic data capture device 216 is one of a Radio-Frequency Identification chip (RFID), a bar code, a matrix code, a magnetic stripe, Optical Character Recognition text (OCR), April tag, Near Field Communication (NFC), Optical Position Marker (OPS), Optical RFID (OPID), RuBee tag, or an integrated circuit.

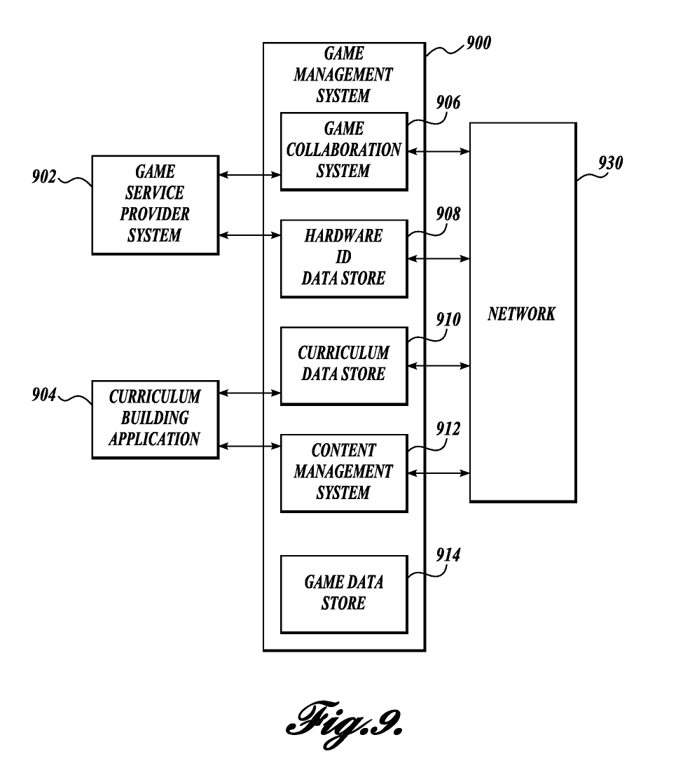

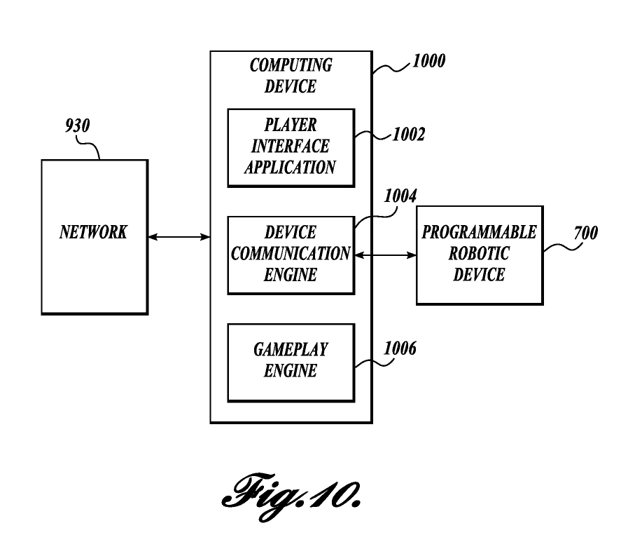

In some embodiments, the game tile information is stored by the automatic data capture device 216 includes at least one of tile identification, tile type and subtype, tile rarity, tile topography, tile terrain, tile environment, tile path layout, character actions, superpowers, rewards, scoring information, ownership history, date, expansion set, artist, designer, and additional programming for the robotic device 700. In other embodiments, the game tile information is stored remotely within a game data store 914 of a game management system 900 (see FIG. 9) which can be queried by the computing device 1000 (see FIG. 8) to access the game tile information. In this regard, the automatic data capture device 216 of the hexagonal game tile 200 includes a unique identifier that is retrieved by the robotic device 700 and indicates which set of game tile information the computing device 1000 should retrieve from the game data store 914. Still, in other embodiments, the game tile information is stored within a data store (not shown) present on the programmable robotic device 700 such that the unique identifier causes the programmable robotic device 700 to directly retrieve the identity of the game tile. In some embodiments, the game tiles of the gameplay system 100 are unique and collectable.

The upper surface of the hexagonal game tile 200 is the travel surface 212 for the programmable robotic device 700. The travel surface 212 includes the travel path 220 to direct the travel direction of the programmable robotic device 700 as a guide to additional target points on other game tiles. The illustrated embodiment includes a linear travel path 220 to each of the interlocking edges 204. In this regard, six travel paths 220 are illustrated in FIG. 2. However, in some embodiments, the travel path 220 is not linear. In other embodiments, fewer travel paths 220 exist than the interlocking edges 204. Still, in other embodiments, any number of travel paths 220 is located on the travel surface 212.

The travel path 220 is attached to the travel surface 212 such that a sensor mounted on the programmable robotic device 700 can detect the travel path 220. In this regard, in some embodiments, the travel path 220 is constructed from materials to enhance sensor detection, including but not limited to infrared sensor paint, sensor pigment enriched paint, a magnetic substrate, textured paper, plastic, and fabric, or a metal. In other embodiments, the travel path 220 does not contain materials to enhance sensor detection (e.g., an eye-visible line of standard paint), and is detectable by an optical sensor (not shown) located on the programmable robotic device 700. The travel path 220 is depicted as residing on the travel surface 212; however, in other embodiments, the travel path 220 is below the travel surface 212.

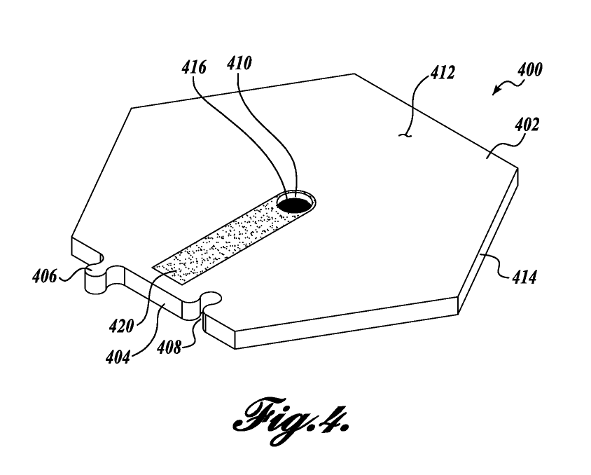

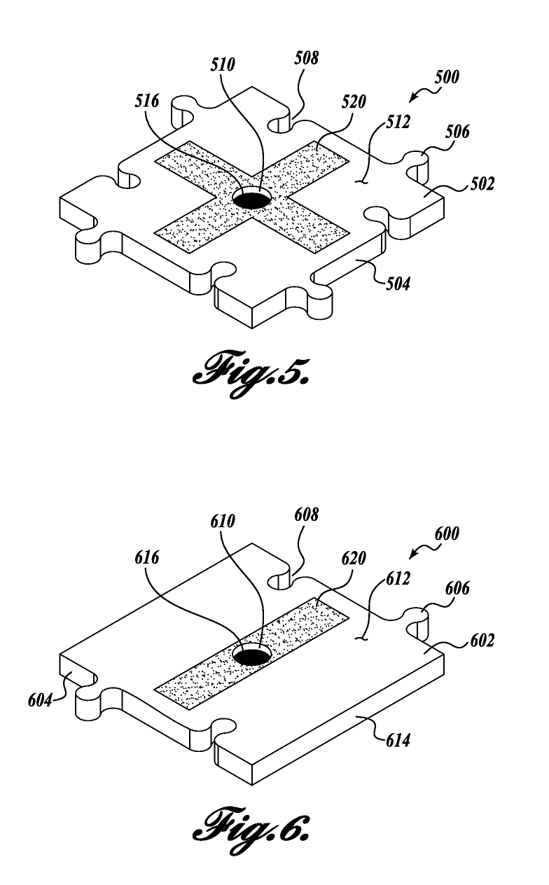

Now referring to FIGS. 3 and 4, additional game tiles in accordance with other embodiments of the present disclosure will be described in more detail.

FIGS. 3 and 4 depict other configurations similar to the hexagonal game tile 200 and are substantially identical as the previously described embodiment, except for difference regarding the interlocking edges and travel paths. For clarity in the ensuing descriptions, numeral reference of like elements of the hexagonal game tile 200 are similar, but are in the 300 series for the embodiment of FIG. 3 and the 400 series for the embodiment of FIG. 4.

Referring to FIG. 3, the hexagonal game tile 300 includes a game tile body 302, an interlocking edge 304 with an interlock tab 306 and an interlock recess 308, a target position 310, a travel surface 312, a non-interlocking edge 314, an automatic data capture device 316, and a travel path 320. The embodiment of FIG. 3 is exemplary of an embodiment having a hexagonal shape with three interlocking edges 304, three non-interlocking edges 314, and three travel paths 320 to the target position 310.

Referring to FIG. 4, the hexagonal game tile 400 includes a game tile body 402, an interlocking edge 404 with an interlock tab 406 and an interlock recess 408, a target position 410, a travel surface 412, a non-interlocking edge 414, an automatic data capture device 416, and a travel path 420. The embodiment of FIG. 4 is exemplary of an embodiment having a hexagonal shape with one interlocking edge 304, five non-interlocking edges 314, and a single travel path 320 to the target position 310. In this regard, the hexagonal game tile 400 may be suitable as a beginning or ending tile of the gameplay system 100 as shown in FIG. 1. In other embodiments, the game tile has any number of travel paths 420, interlocking edges 404, and non-interlocking edges 414.

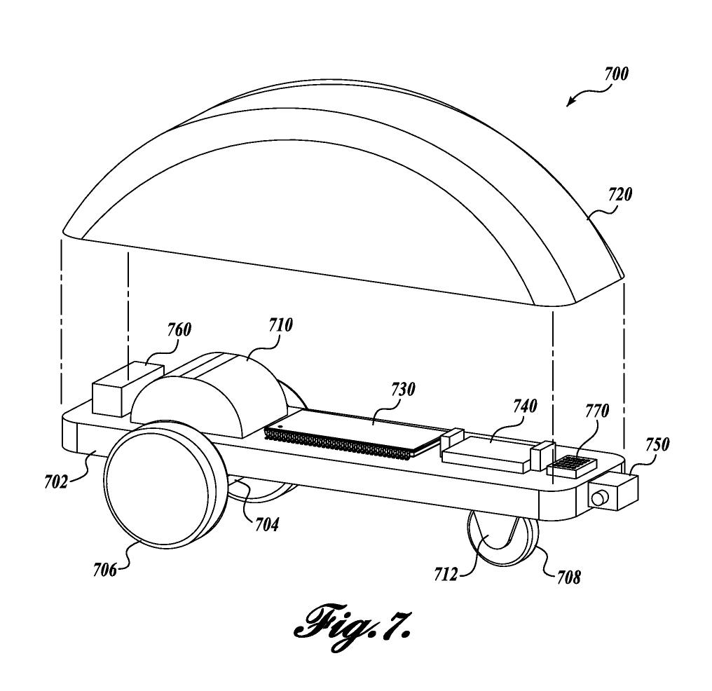

Now referring to FIGS. 5 and 6, additional game tiles in accordance with other embodiments of the present disclosure will be described in more detail. FIGS. 5 and 6 depict configurations of a square-shaped game tile with features that are substantially identical to the previously described embodiments related to the hexagonal-shaped tiles, except with fewer sides. For clarity in the ensuing descriptions, numeral reference of like elements to the hexagonal game tile 200 are similar, but are in the 500 series for the embodiment of FIG. 5 and the 600 series for the embodiment of FIG. 6.

Referring to FIG. 5, the square game tile 500 includes a game tile body 502, an interlocking edge 504 with an interlock tab 506 and an interlock recess 508, a target position 510, a travel surface 512, an automatic data capture device 516, and a travel path 520. The embodiment of FIG. 5 is similar to the hexagonal game tile 200 except with four interlocking edges 504 and four travel paths 520 to the target position 510.

Referring to FIG. 6, the hexagonal game tile 600 includes a game tile body 602, an interlocking edge 604 with an interlock tab 606 and an interlock recess 608, a target position 610, a travel surface 612, a non-interlocking edge 614, an automatic data capture device 616, and a travel path 620. The embodiment of FIG. 6 is exemplary of an embodiment having a square shape as in the square game tile 500, except with two interlocking edges 604, two non-interlocking edges 614, and two travel paths 620 to the target position 610. In this regard, the square game tile 600 may be suitable as a bridge or connecting tile of the gameplay system 100 as shown in FIG. 1. In other embodiments, the game tile has any number of travel paths 620, interlocking edges 604, and non-interlocking edges 614.

While both hexagonal and square game tile shapes have been illustrated and described, other embodiments of the present disclosure include tiles of any suitable shape. Likewise, any suitable travel path route is within the scope of the present disclosure. The travel surface of any of the embodiments may suitably include graphics to illustrate unique characteristics or environments of the game tiles. Additionally, an eye-visible representation of the contents of the automatic data capture device of any of the game tile embodiments may be included on the surfaces of the game tiles.

As shown in FIG. 1, when two or more game tiles are releasably coupled, the travel paths align to allow the programmable robotic device 700 to have a complete travel route (comprising at least one travel path from each of two game tiles) from the target position of a first game tile to the target position of a second game tile. As illustrated most clearly in FIG. 1, it is not a requirement for the travel paths to connect or touch for the travel route to be complete for travel by the programmable robotic device 700.

Now referring to FIG. 7, the programmable robotic device 700 in accordance with one embodiment of the present disclosure will be described in more detail. The programmable robotic device 700 includes a robot chassis 702, a drive axle 704 with an attached drive wheel 706 and a drive motor 710, a tracking wheel 708 attached to the robot chassis 702 through a tracking wheel support 712, a robot shell 720, a microprocessor 730, an automatic data capture sensor 740, a path sensor 750, a power source 760, and an audio device 770. The programmable robotic device 700 is configured to travel from the target point of a first game tile to the target point of a second game tile along the travel path and perform an action at the target position of the second tile.

The programmable robotic device 700 is supported by the robot chassis 702. In some embodiments, the robot chassis 702 is integrated as a circuit board (not shown). In other embodiments, the robot chassis 702 is as separate component, suitably manufactured from metal or plastic. The robot chassis 702 provides support and mounting locations for the other components of the programmable robotic device 700.

In accordance with one embodiment, the programmable robotic device 700 travels along the travel path of the game tiles using the drive wheels 706 and the tracking wheel 708. The drive wheels 706 are connected by a drive axle 704 and provide propulsion for movement of the programmable robotic device 700. The tracking wheel 708 provides balanced support such that the programmable robotic device 700 does not tip during movement or programmed actions. In other embodiments, the tracking wheel may be a low-friction skid pad, a ball, or any other suitable device to prevent loss of balance. In other embodiments, any suitable wheel configuration may be used to provide stable movement of the programmable robotic device 700.

The drive wheels 706 are driven through the drive axle 704 by the drive motor 710. The drive motor 710 is controlled by the microprocessor 730 in accordance with the programming provided by the game management system 900 (see FIG. 9) or the automatic data capture device of the game tiles. The drive motor 710 utilizes a power source 760 for electric power. The drive motor 710 is configured to rotate in forward and reverse directions. The transmission (not shown) is generally known in the art and provides a transfer of power from the drive motor 710 to the drive axle 704. In some embodiments, the drive wheels 706 may be individually driven through separate drive axles 704 and separate drive motors 710 for additional maneuverability of the programmable robotic device 700. Further, in other embodiments, any suitable drive configuration is used to propel the programmable robotic device 700.

The programmable robotic device 700 includes the automatic data capture sensor 740 and the path sensor 750, both controlled by the microprocessor 730, to allow accurate travel along the travel path of the game tiles and interrogation of the automatic data capture device of the game tiles. In some embodiments, the automatic data capture sensor 740 is electrically connected to the microprocessor 730 and is configured to read the data capture device of the game tile, as noted above, comprising a type of either a Radio-Frequency Identification chip (RFID), a bar code, a matrix code, a magnetic stripe, Optical Character Recognition text (OCR), an April tag, an NFC tag, an Optical Position Marker (OPS), an Optical RFID (OPID), a RuBee Tag, or an integrated circuit. For example, if the automatic data capture device is an RFID chip, the automatic data capture sensor 740 is an RFID chip reader. Likewise, if the automatic data capture device is a bar code, the automatic data capture sensor 740 is a bar code reader. If the automatic data capture device is a matrix code, the automatic data capture sensor 740 is a matrix code reader. If the automatic data capture device is text for OCR, the automatic data capture sensor 740 is a camera that is coupled to a microprocessor that can perform OCR on images received by the camera. If the automatic data capture device is an April tag, the automatic data capture sensor 740 is an April tag sensor. If the automatic data capture device is an NFC tag, the automatic data capture sensor 740 is an NFC tag sensor. If the automatic data capture device is an OPS, the automatic data capture sensor 740 is an OPS sensor. If the automatic data capture device is an OPID, the automatic data capture sensor 740 is an OPID sensor. If the automatic data capture device is a RuBee tag, the automatic data capture sensor 740 is a RuBee tag sensor. If the automatic data capture device is an integrated circuit, the automatic data capture sensor 740 is a sensor capable of reading an integrated circuit. In other embodiments, the programmable robotic device 700 includes automatic data capture sensors for all the types of automatic data capture devices such that any automatic data capture device may be used and interrogated by the programmable robotic device 700 upon reaching the target position of the game tile.

The path sensor 750 is electrically connected to the microprocessor 730 and is configured to direct the programmable robotic device 700 along the travel path or travel route from the target position of a first game tile to the target position of a second game tile. In this regard, the path sensor 750 is configured to sense the material used for the travel paths of the game tiles, as noted above as comprising materials to enhance sensor detection, including either infrared sensor paint, sensor pigment enriched paint, a magnetic substrate, a textured surface, or a metal. For example, if the travel paths are painted on the travel surface of the game tile with infrared sensor paint, the path sensor 750 is an infrared sensor. Likewise, if the travel paths are painted on the travel surface with sensor pigment enriched paint, the path sensor 750 is a sensor capable of detecting pigment. If the travel paths are a magnetic substance on the travel surface of the game tile, the path sensor 750 is a magnetic sensor. If the travel paths are textured surfaces on the travel surface of the game tile, the path sensor 750 is a camera. If the travel paths are metallic on the travel surface of the game tile, the path sensor 750 is a magnetic sensor. In other embodiments, the programmable robotic device 700 includes path sensors for all the types of travel path materials such that any sensor material may be used and accurately followed by the programmable robotic device 700 upon travel along the travel paths of the game tiles. Additionally, in other embodiments, an optical sensor may be used as the path sensor 750. In this regard, the travel path material may be any optically distinguishable material to accurately direct the programmable robotic device 700 along the travel path. In embodiments of the present disclosure, the programmable robotic device 700 utilizes known path-following techniques to follow the travel path.

The robot shell 720 is removably coupled to the robot chassis 702. The robot shell 720 surrounds the components attached to the robot chassis 702, such as the drive motor 710, the microprocessor 730, the automatic data capture device sensor 740, the path sensor 750, the power source 760, and the audio device 770. In one embodiment, the robot shell 720 is made in the shape of a character of the interactive gameplay system 800, for example, in the likeness of an animal or insect. In this regard, the robot shell 720 may be translucent or opaque, and may include designs and features corresponding to the representative likeness. In other embodiments, the robot shell 720 includes paint to enhance the aesthetics of the programmable robotic device 700. In other embodiments, the robot shell 720 is suitably any shape to cover the components of the programmable robotic device 700. Still, in other embodiments, additional decorations (not shown) may be included to add further aesthetics to the programmable robotic device 700. Decoration examples are collectable badges, jewels and pins.

In some embodiments, the robot shell 720 is electrically connected to the microprocessor 730 such that a unique identification of the robot shell 720 can be detected by the microprocessor 730. In this regard, the robot shell 720 may include an automatic data capture device (not shown) or a data storage device (not shown). The unique identification carried by the robot shell 720 is capable of altering the behavior of the programmable robotic device through one or more of the actions, the superpowers, the sounds, and the general gameplay. For example, if an embodiment of the robot shell 720 is shaped to represent the likeness of a bumblebee, the unique identification may cause the programmable robotic device 700 to alter the performance of actions to mimic the movement of a bumblebee, only travel to select game tiles, and/or emit representative bumblebee noises through an audio device 770.

The actions performed by embodiments of the programmable robotic device are numerous and generally well-known in the art, such as traveling forward, traveling backward, turning each direction, jumping, squatting, flipping, stopping, etc. Additional actions performed by the programmable robotic device 700 are also within the scope of this disclosure. Superpowers, as mentioned above, may include additional abilities, sounds, scoring, or actions performed by the programmable robotic device 700. In this regard, the superpowers are generally reserved for rewarding a player for completing an action, distinguishing between characters or robot shells 720, or advancing the development of a player's character. Other uses for superpowers within the game are also within the scope of this disclosure.

Referring now to FIG. 8, an overview of the interactive game system 800 is shown. The interactive game system 800 includes the aforementioned components of the gameplay system 100, including the game tiles 200, 300, 400, 500, and 600, and the programmable robotic device 700. In addition, the interactive game system 800 includes a game management system 900 connected to a computing device 1000 through the use of a network 930. The network 930 is chosen from any suitable network, including but not limited to a Local Area Network (LAN), a Wide Area Network (WAN), and the Internet. In certain embodiments of the present disclosure, the game management system 900 and the computing device 1000 are used in conjunction with the gameplay system 100 during play.

The game management system 900 is shown in greater detail in FIG. 9. The game management system communicates with a game service provider system 902 and a curriculum building application 904. In some embodiments, the game service provider system 902 is maintained and programmed by the vendor of the interactive gameplay system 800. In this regard, the game service provider system 902 stores one or more of the rules of gameplay, player interaction rules, multiple player rules, actions, unique superpower identification information, unique superpower combination, unique shell identification information, unique tile identification information, unique character identification information, and player statistics. In other embodiments, any pertinent game information is stored on the game service provider system 902.

In some embodiments, the curriculum building application 904 is used in conjunction with the interactive game system 800. The curriculum building application 904 is an application that can be used by a player or a supervisor of gameplay (e.g., a teacher) to build a curriculum upon which a player will follow during gameplay. The curriculum building application 904 may suitably allow for one or more of planning of game tile layout, actions, travel path selection, scoring, time to complete gameplay, character selection, superpowers, and robot shell types. The curriculum building application 904 tracks data analytics related to gameplay. Metrics tracked by the curriculum building application 904 include but are not limited to time on task, levels completed, number of attempts of a specific level, collaborative versus individual play and player ranking in absolute or relative format. The curriculum building application 904 allows for tracking of gameplay in real time based off of incremental data collected by the robot as it navigates the tiles. The curriculum building application 904 supports cataloging and ranking of specific tile configurations (puzzles). In another embodiment, the curriculum building application 904 is used for any suitable use within the playing parameters of the interactive game system 800.

As illustrated in FIG. 9, the game management system 900 includes a game collaboration system 906, a hardware identification (ID) data store 908, a curriculum data store 910, a content management system 912, and a game data store 914. The game collaboration system 906 controls the interactions related to multiple player scenarios. For example, if the gameplay system 100 includes multiple programmable robotic devices 700 using the same game tiles 200, 300, 400, 500, and/or 600, the game collaboration system 906 issues a set of instructions to allow for interaction of the characters.

The hardware ID data store 908 is managed by the game vendor and includes information on the properties related to different physical hardware components, such as the robot shell 720 and game tiles 200, 300, 400, 500, and 600. In some embodiments, the hardware ID data store 908 includes information related to the representative character, the actions, superpowers, sounds, the game tile type, etc.

The curriculum data store 910 includes gameplay curriculum to be communicated to the player through the computing device 1000 and additionally to the programmable robotic device 700. In this regard, the vendor may manage the curriculum data store 910. Additionally, the curriculum building application 904 may alter and store curriculum in the curriculum data store 910. Likewise, the content management system 912 includes gameplay content to be communicated to the player through the computing device 1000 and additionally to the programmable robotic device 700. The game data store 914 provides storage for the multiple components of the game management system 900. The network 930 is generally of the type known in the art and allows the game management system 900 to reciprocally communicate with the computing device 1000.

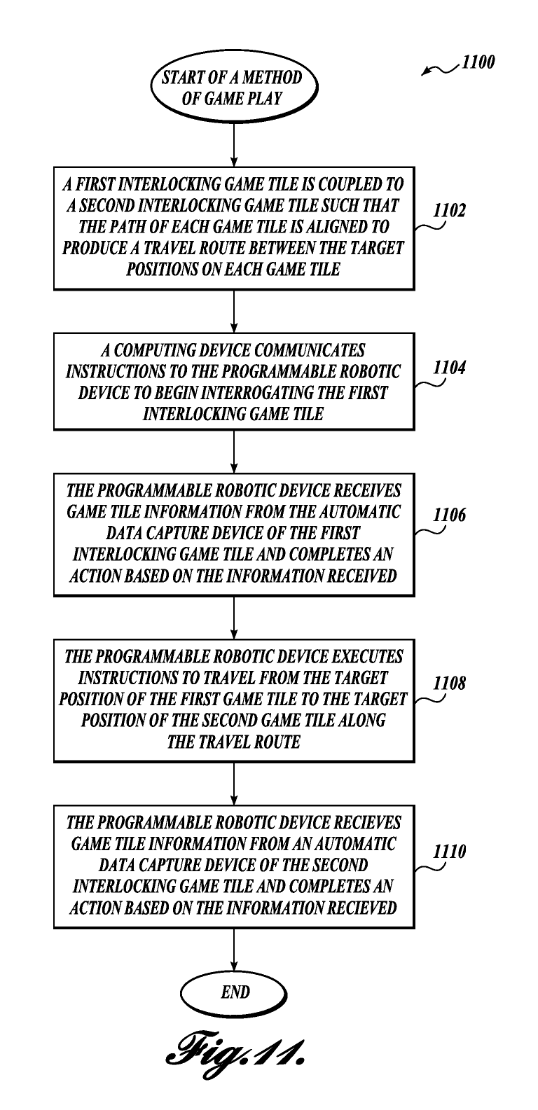

The computing device 1000 is shown in FIG. 10. The computing device 1000 generally includes a player interface application 1002, a device communication engine 1004, and a gameplay engine 1006. The separate systems of the computing device 1000 allow a user or player to program, control, and gain feedback from the programmable robotic device 700 during gameplay. The player interface application 1002 gives a graphical and/or textual representation of the game layout, content, actions, characters, scoring, multiple player status, and progress during gameplay. The player interface application 1002 may also provide rewards, performance feedback, display of badges, awards, and completed level information. The device communication engine 1004 allows the computing device 1000 to communicate with the programmable robotic device 700 during gameplay. Communication with the programmable robotic device 700 by the device communication engine 1004 may be performed using any suitable communication technique generally known, including but not limited to Bluetooth, WiFi, infrared (IR) remote, radio frequency (RF) remote, ultrasonic remote, Near-Field Communication (NFC), and VHF radio. The suitable transmitters and sensors for the communication technologies described above are omitted from the FIGURES for clarity, but are generally known and are within the scope of this disclosure. The gameplay engine 1006 powers the features of the game during gameplay.

Embodiments of a method of gameplay are shown in FIG. 11 and are now described in more detail. In some embodiments, the gameplay includes using interlocking game tiles 200, 300, 400, 500, and/or 600. In other embodiments, any game tile combination is suitably used for gameplay. As an illustrative example using a two-tile game layout with interlocking game tiles 200 and 300, the method includes coupling the interlocking component (e.g., interlocking edge 204) of a first interlocking game tile 200 to the interlocking component (e.g., interlocking edge 304) of a second interlocking game tile 300, thereby aligning the travel path 220 of the first interlocking game tile 200 and the travel path 320 of the second interlocking game tile 300 which together produce the travel route between the target position 210 and the target position 310, as described in block 1102 of the method.

Next, in block 1104, the computing device 1000 communicates instructions to the programmable robotic device 700 to begin interrogating the first interlocking game tile 200. Advancing to block 1106, the programmable robotic device 700 receives game tile information from the automatic data capture device 216 of the first interlocking game tile 200, and then completes an action based on the game tile information received from the first interlocking game tile 200. The performed action may include one or more of movement, emitting sounds, advancing the score, giving the player further instructions, goals, awards, triggering messages sent to multiple computing devices connected to the gameplay system 100, changing the superpowers of the character, upgrading the character capabilities, and continuing to the next game tile along the travel route.

Next, moving to block 1108 of the method, the programmable robotic device 700 executes instructions to travel from the target position 210 of the first interlocking game tile 200 to the target position 310 of the second interlocking game tile 300, along the travel route represented by the travel paths 220 and 320. In some embodiments, the instructions to travel to the next game tile are automatically built into the game content. In other embodiments, the programmable robotic device waits to receive instructions from the computing device 1000 before advancing to a different game tile. In the illustrative example of FIG. 11, once the target position 310 is reached, the programmable robotic device 700 begins interrogating the automatic data capture device 316 of the second interlocking game tile 300.

Finally, moving to block 1110, the programmable robotic device 700 receives game tile information of the second interlocking game tile 300 from the automatic data capture device 316. The programmable robotic device 700 will then complete an action based on the game tile information received from the second interlocking game tile. As before, the actions may include one or more of movement, emitting sounds, advancing the score, giving the player further instructions, changing the superpowers of the character, upgrading the character capabilities, and continuing to the next game tile along the travel route. The method of gameplay in the illustrated embodiment is then ended.

In other embodiments of the method of gameplay, the robot shell 720 transmits a unique identifier to the microprocessor 730 such that the actions of the programmable robotic device 700 change, including superpowers, characters, and action capabilities.

In another embodiment of the method of gameplay, multiple users share the same game tiles and interact using the game collaboration system 906.

A more specific example of the method of gameplay by a player will now be explained in detail. In this regard, the foregoing example is not to be construed as limiting with respect to the gameplay method of gameplay options of the present disclosure, and is intended to be illustrative of one possible embodiment of the method of gameplay using the interactive game system of the present disclosure. This example will make use of the game tile layout of FIG. 1, for clarity.

In this example, the method of gameplay steps is as follows:

(1) The player interface application 1002 of the computing device 1000 receives a game layout from the game management system 900, and the layout displays a graphic showing, or text outlining a travel route and any actions that the programmable robotic device 700 should perform to complete the phase of the game (e.g., a game level). In the example using FIG. 1, if the hexagonal game tile 400 is the starting point, the path may be “move forward 1 tile,” “turn left 60 degrees and move forward 1 tile,” “spin 360 degrees and move forward 1 tile,” “turn right 60 degrees and move forward 2 tiles,” and “end,” which would end on the hexagonal game tile 200 following the layout of FIG. 1.

(2) The player selects game tiles to perform the stated actions and complete the given travel route. The player removably couples the game tiles together in the pattern given by the instructions in step (1).

(3) The player places the programmable robotic device 700 on the starting game tile, hexagonal game tile 400 in this example, and instructs the phase of the game to begin using the computing device 1000.

(4) The device communication engine 1004 instructs the programmable robotic device 700 to begin performing the actions, starting with moving forward 1 tile to the hexagonal game tile 300 as shown in FIG. 1.

(5) The programmable robotic device 700 uses the path sensor 750 to move forward to the hexagonal game tile 300 along the travel paths 220 and 320 until it senses the automatic data capture device 316 at hexagonal game tile 300, which marks the target position 310.

(6) The programmable robotic device 700 stops at the target position 310, interrogates the automatic data capture device 316, and sends at least some of the game tile information of the hexagonal game tile 300 to the computing device 1000.

(7) The computing device 1000 uses the player interface application 1002 to update and inform the player of the game state and the progress toward completing the phase of the game. In the event that the player selects the wrong game tiles or assembles the game tiles in the wrong layout, the player interface application would communicate the error to the player and provide instructions to the player regarding how the game tile selection and layout could be remedied to complete the phase of the game.

(8) The programmable robotic device 700 finds an instruction in the game tile information received from the automatic data capture device 316 instructing it to turn left 60 degrees and move forward to the next tile, which is the square game tile 600 in the example shown in FIG. 1.

(9) The programmable robotic device 700 turns 60 degrees left and again moves forward until it senses the automatic data capture device 616, where it repeats steps (6), (7), (8), and (9) until the final hexagonal game tile 200 is reached.

(10) The programmable robotic device 700 sends information to the computing device 1000 that the final game tile has been reached. The player interface application 1002 may indicate that the game is complete, issue another travel route for further gameplay, update scores, allow another player to take a turn, etc.

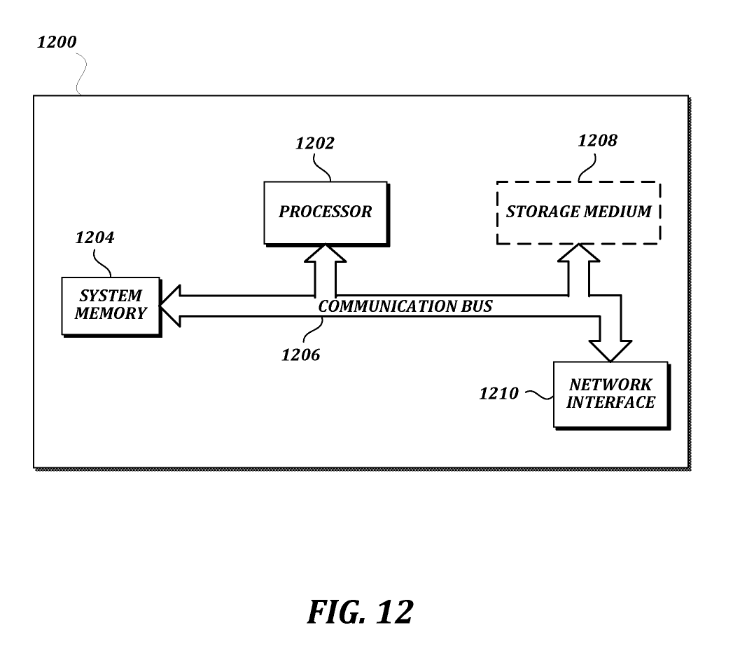

FIG. 12 is a block diagram that illustrates aspects of an exemplary computing device 1200 appropriate for use as a computing device of the present disclosure (see FIG. 10). The exemplary computing device 1200 describes various elements that are common to many different types of computing devices suitable for use as a computing device in the presently disclosed system, including desktop computers, laptop computers, smartphones, tablet computers, and/or the like. While FIG. 12 is described with reference to a computing device that is implemented as a device on a network, the description below is applicable to servers, personal computers, mobile phones, smart phones, tablet computers, embedded computing devices, and other devices that may be used to implement portions of embodiments of the present disclosure. Moreover, those of ordinary skill in the art and others will recognize that the computing device 1200 may be any one of any number of currently available or yet to be developed devices.

In its most basic configuration, the computing device 1200 includes at least one processor 1202 and a system memory 1204 connected by a communication bus 1206. Depending on the exact configuration and type of device, the system memory 1204 may be volatile or nonvolatile memory, such as read only memory (“ROM”), random access memory (“RAM”), EEPROM, flash memory, or similar memory technology. Those of ordinary skill in the art and others will recognize that system memory 1204 typically stores data and/or program modules that are immediately accessible to and/or currently being operated on by the processor 1202. In this regard, the processor 1202 may serve as a computational center of the computing device 1200 by supporting the execution of instructions.

As further illustrated in FIG. 12, the computing device 1200 may include a network interface 1210 comprising one or more components for communicating with other devices over a network. Embodiments of the present disclosure may access basic services that utilize the network interface 1210 to perform communications using common network protocols. The network interface 1210 may also include a wireless network interface configured to communicate via one or more wireless communication protocols, such as WiFi, 2G, 3G, LTE, WiMAX, Bluetooth, and/or the like.

In the exemplary embodiment depicted in FIG. 12, the computing device 1200 also includes a storage medium 1208. However, services may be accessed using a computing device that does not include means for persisting data to a local storage medium. Therefore, the storage medium 1208 depicted in FIG. 12 is represented with a dashed line to indicate that the storage medium 1208 is optional. In any event, the storage medium 1208 may be volatile or nonvolatile, removable or nonremovable, implemented using any technology capable of storing information such as, but not limited to, a hard drive, solid state drive, CD ROM, DVD, or other disk storage, magnetic cassettes, magnetic tape, magnetic disk storage, and/or the like.

As used herein, the term “computer readable medium” includes volatile and non-volatile and removable and non-removable media implemented in any method or technology capable of storing information, such as computer readable instructions, data structures, program modules, or other data. In this regard, the system memory 1204 and storage medium 1208 depicted in FIG. 12 are merely examples of computer readable media.

Suitable implementations of computing devices that include a processor 1202, system memory 1204, communication bus 1206, storage medium 1208, and network interface 1210 are known and commercially available. For ease of illustration and because it is not important for an understanding of the claimed subject matter, FIG. 12 does not show some of the typical components of many computing devices. In this regard, the computing device 1200 may include input devices, such as a keyboard, keypad, mouse, microphone, touch input device, touch screen, tablet, and/or the like. Such input devices may be coupled to the computing device 1200 by wired or wireless connections including RF, infrared, serial, parallel, Bluetooth, USB, or other suitable connections protocols using wireless or physical connections. Similarly, the computing device 1200 may also include output devices such as a display, speakers, printer, etc. Since these devices are well known in the art, they are not illustrated or described further herein.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. An interlocking tile for directing an action of a programmable robotic device, comprising:
a body having a top surface and an edge portion, the edge portion having an interlocking component;
an automatic data capture device associated with the body configured for storage of tile information and identification of a target position; and
a path disposed on the top surface of the body connecting the edge portion and the target position, the path indicative of a travel route to the target position for the programmable robotic device,
wherein the interlocking component is removably couplable to an interlocking component of an edge portion of a second interlocking tile, and wherein the programmable robotic device is configured to interrogate the automatic data capture device to receive the tile information.

2. The interlocking tile of claim 1, wherein the automatic data capture device is selected from the group consisting of Radio-Frequency Identification (RFID), a bar code, a matrix code, a magnetic stripe, Optical Character Recognition (OCR), April tag, Near Field Communication (NFC), Optical Position Marker (OPS), Optical RFID (OPID), RuBee tag, and an integrated circuit.

3. The interlocking tile of claim 1, wherein a portion of the tile information received from the automatic data capture device is a location of the target position.

4. The interlocking tile of claim 3, wherein the target position is the center of the top surface of the interlocking tile.

5. The interlocking tile of claim 1, wherein a portion of the tile information received from the automatic data capture device is a tile type.

6. The interlocking tile of claim 5, wherein the tile type includes a unique identifier corresponding to one or more of a terrain, an environment, a superpower, and an action to be completed by the programmable robotic device.

7. The interlocking tile of claim 1, wherein the path comprises a sensor material such that the travel route is detectable by sensors disposed on the programmable robotic device.

8. The interlocking tile of claim 7, wherein the travel route guides the programmable robotic device to a target position of the second interlocking tile.

9. The interlocking tile of claim 7, wherein the sensor material is selected from the group consisting of an infrared sensor paint, a sensor pigment enriched paint, a magnetic substrate, textured paper, textured plastic, textured fabric, a metal, and an eye-visible line.

10. A system, comprising:
a tile, comprising:
a tile body having a top surface and an edge portion, the edge portion having an interlocking component;
an automatic data capture device associated with the tile body configured for identification of a target position; and
a path disposed on the top surface of the tile body connecting the edge portion and the target position, the path indicative of a travel route to the target position; and
a programmable robotic device, comprising:
a robot body;
a microprocessor connected to the robot body;
a sensor electrically connected to the microprocessor for detecting the path of the tile;
an automatic data capture device reader electrically connected to the microprocessor for interrogating and receiving tile information from the automatic data capture device of the tile;
an electric motor associated with the microprocessor; and
a wheel drivingly connected to the electric motor for propelling the programmable robotic device,
wherein the microprocessor is configured to cause the programmable robotic device to travel along the travel route to the target position and complete the actions directed by the tile.

11. The system of claim 10, wherein the interlocking component is removably couplable to an interlocking component of an edge portion of a second tile, wherein the path of the first tile and a path of the second tile together form the travel route, and wherein the programmable robotic device is configured to travel along the travel route from the target position of the first tile to a target position of the second tile and complete actions directed by the second tile.

12. The system of claim 10, wherein the automatic data capture device of the tile stores information related to the type of tile and the actions the programmable robotic device completes when the target position is reached.

13. The system of claim 12, wherein the automatic data capture device is selected from the group consisting of Radio-Frequency Identification (RFID), a bar code, a matrix code, a magnetic stripe, Optical Character Recognition (OCR), April tag, Near Field Communication (NFC), Optical Position Marker (OPS), Optical RFID (OPID), RuBee tag, and an integrated circuit.

14. The system of claim 10, wherein the programmable robotic device further comprises a wireless communication device configured to communicate with a computing device to receive programming instructions.

15. The system of claim 10, wherein the programmable robotic device further comprises an exterior shell disposed around the robot body, wherein the shell is electrically connected to the microprocessor and configured to transmit characteristics and identity of the shell.

16. The system of claim 15, wherein the characteristics of the shell include a unique identifier corresponding to one or more of a character, a superpower, and an action to be completed by the programmable robotic device.

17. A method, using interlocking game tiles of claim 1, the method comprising:
coupling the interlocking component of a first interlocking tile to the interlocking component of a second interlocking tile, wherein the path of the first interlocking tile and the path of the second interlocking tile are aligned and together produce the travel route between the target position of the first interlocking tile and the target position of the second interlocking tile;
communicating, by a computing device, instructions to the programmable robotic device to begin interrogating the first interlocking tile;
receiving, by the programmable robotic device from the automatic data capture device, tile information from the first interlocking tile to the programmable robotic device, wherein the programmable robotic device completes an action based on the tile information received from the first interlocking tile;
executing instructions by the programmable robotic device that cause the programmable robotic device to travel from the target position of the first interlocking tile to the target position of the second interlocking tile along the travel route and begin interrogating the automatic data capture device of the second interlocking tile; and
receiving, by the programmable robotic device from the automatic data capture device, tile information from the second interlocking tile, wherein the programmable robotic device completes an action based on the tile information received from the second interlocking tile.

18. The method of claim 17, wherein the programmable robotic device does not travel from the target position of the first interlocking tile to the target position of the second interlocking tile until receiving the instructions from a computing device.

19. The method of claim 17, wherein the programmable robotic device has a shell configured to transmit a unique identifier corresponding to one or more of a character, a superpower, and a further action to be completed by the programmable robotic device.

20. The method of claim 17, wherein the automatic data capture device is selected from the group consisting of Radio-Frequency Identification (RFID), a bar code, a matrix code, a magnetic stripe, Optical Character Recognition (OCR), April tag, Near Field Communication (NFC), Optical Position Marker (OPS), Optical RFID (OPID), RuBee tag, and an integrated circuit.
